(19) United States
(12) Patent Application Publication
(10) Pub. No.: US 2020/0202661 A1
(43) Pub. Date: Jun. 25, 2020

(54) GAMING SYSTEM PROVIDING WHEELS AND REELS GAME

(71) Applicant: ADP GAUSELMANN GMBH, Espelkamp (DE)

(72) Inventor: Michael Charles Halvorson, Las Vegas, NV (US)

(21) Appl. No.: 16/230,692

(22) Filed: Dec. 21, 2018

(51) Int. Cl. G07F 17/32; G07F 17/34

(52) U.S. Cl. CPC G07F 17/3213; G07F 17/34; G07F 17/3244

(57) ABSTRACT

The present disclosure provides systems and processes for gaming. A gaming system consistent with the present disclosure provides a reel and wheel game in which game reels function in cooperation with game wheels. The game wheels can include wheel symbol display areas aligned with rows of the reels. The wheels can rotate and the reels can spin together or independently to display randomly selected combinations of symbols. The gaming system can evaluate the symbols displayed on the wheels and reels to determine awards based on winning combinations of symbols displayed by the wheel and reels.

### FIELD

The present disclosure relates to gaming systems.

### BACKGROUND

Gaming systems accept wagers from players in exchange for opportunities to win awards or prizes. Current gaming systems combine various specialized computing technologies to provide systems adapted to gain the attention of players and to keep them engaged with the gaming systems. To retain players' interest, gaming systems that offer new and unconventional functionality are needed.

### SUMMARY

The present disclosure is directed to systems and processes for gaming. A gaming system consistent with the implementations disclosed herein provides a game that randomly determines symbols and displays such symbols to players using a display device. The gaming system evaluates the displayed symbols to determine whether they correspond to predetermined awards. Implementations of a gaming system in accordance with aspects of the present disclosure provide a game combining different types of game displays. More specifically, implementations of gaming systems consistent with those disclosed herein display a screen for a game including game reels functioning in co-operation with one or more game wheels. In some implementations, the game wheels are comprised of symbol display areas (e.g., segments of a circular array) that are aligned with one or more rows of the game reels. In one example, the slot machine can include a 5-column by 3-row array of symbol display areas, wherein three symbol display areas of a game wheel are horizontally aligned with the three rows of the reels. In another example, the game reels can be a 5-column by 4-row array of symbol display areas, wherein four symbol display area of the game wheels are horizontally aligned with the four rows of the reels.

During a game, the gaming system can display the game reels spinning and the game wheels rotating, before coming to a stop so as to display randomly selected symbols. The reels can spin and wheels can rotate and/or stop at the same time, overlapping times, or at different times, and in one or more directions. The gaming system can evaluate the symbols displayed on the wheels and the reels to determine one or more awards. In some implementations, the gaming system can use one or more pay tables to determine awards based on winning combinations of symbols displayed on the game reels and the game wheels. In some implementations, the winning combinations of symbols are based solely on the symbols displayed on the reels, and the symbols on the game wheels modify (e.g., add, multiply, etc.) such awards, the play of the game, or both. For example, the game wheels can display prize value symbols, multiplier symbols, trigger symbols, collectable symbols, and symbol modifiers. Additionally, in some implementations, the symbols displayed on the game wheels can function as additional reel symbols that form winning symbol combinations with the reel symbols so as to provide different awards than are provided by winning combinations of reel symbols alone.

As described above and set forth in greater detail below, gaming systems in accordance with aspects of the present disclosure provide a specialized computing device integrating non-generic hardware and software that improve upon the existing technology of human-computer interfaces by providing unconventional functionality for generating interactive displays and outputs. The disclosed features improve the operation of the gaming systems for their specialized purpose of providing entertainment by reducing player disappointment with game outcomes, by enhancing player enjoyment, and by increasing player engagement.

Additionally, the features described herein technically improve the operation of gaming systems for their specialized purpose by integrating two different types of game displays (e.g., a reel-type game display and a wheel-type game display) into a single game presented on a game screen, such that at least some implementations of the game provide the two types of game displays substantially concurrently (e.g., at overlapping times, simultaneously, or substantially simultaneously) and can operate such game displays in cooperation with each other. In some implementations, concurrently providing the two types of game displays on a game screen of one display device technically improves the gaming system by reducing the number of display devices used by the gaming system and, thereby, reducing power consumption used by the gaming system in comparison to systems presenting such game displays on separate display devices. Further implementations in which the gaming system is implemented with one display device, rather than multiple display devices, the physical complexity and manufacturing cost of the gaming system can also be reduced. Still further, in some implementations, by providing the two types of game displays concurrently and in coordination, games initiated by gaming systems in accordance with the present disclosure can be completed more quickly than systems that provide such game displays separately (e.g., a reel-type game that, after completion, is followed by a wheel-type game). By doing so, in some implementations, the disclosed gaming systems can increase the usage rate of the gaming system by allowing more games to be completed in a given time period (e.g., games per hour) and by reducing power consumed during one or more plays of a game.

Moreover, in some implementations, generating and displaying two different types of game displays on a game screen substantially concurrently reduces processing load and memory consumption of the gaming system. That is, in some implementations, the gaming system may generate and display one type of game display overlapping the second type of game display. For example, a display of a reel-type game display may overlap portions of a wheel-type game display concurrently displayed in a game screen (such as shown in FIG. 4A below). By doing so, implementations of the disclosed gaming system avoid generating, displaying, and evaluating the occluded portions of the second game display, which increases the efficiency of the gaming system by conserving processing load and reducing memory consumption. And, when such efficiency improvements are made and applied to hundreds or thousands of game evaluations performed in multiple installations of the gaming system (e.g., multiple devices installed at a casino), implementations of the disclosed gaming system provide casino game operators substantial gains in machine efficiency, which is another technological improvement.

### BRIEF DESCRIPTION OF THE DRAWINGS

FIG. 1 shows a perspective view illustrating an example gaming device in accordance with aspects of the present disclosure.

FIG. 2 shows a functional block diagram illustrating a game controller and gaming system in accordance with aspects of the present disclosure.

FIG. 3A shows a process flow diagram illustrating an example method of operating the gaming system in accordance with aspects of the present disclosure.

FIG. 3B shows a process flow diagram illustrating an example method of operating the gaming system in accordance with aspects of the present disclosure.

FIG. 3C shows a process flow diagram illustrating an example method of operating the gaming system in accordance with aspects of the present disclosure.

FIG. 4A shows a picture of a game screen displayed by a gaming system in accordance with aspects of the present disclosure.

FIG. 4B shows a picture of a game screen displayed by a gaming system in accordance with aspects of the present disclosure.

FIG. 4C shows a picture of a game screen by a gaming system in accordance with aspects of the present disclosure.

### DETAILED DESCRIPTION

The present disclosure provides systems and processes for gaming. As detailed previously herein, a gaming system consistent with the present disclosure provides a display screen for a game combining game reels the function cooperation with one or more game wheels. In implementations, the game wheels can comprise wheel symbol display areas (e.g., sections of the game wheel) arranged in a circular array aligned with rows of reel symbol display areas (rows of game reels) arranged in a rectangular array. The game wheels can spin and stop together or independently of the game reels rotation to display randomly selected combinations of symbols. The gaming system can evaluate the symbols displayed on the wheels and reels to determine one or more awards. In some implementations, the gaming system can determine awards based on winning combinations of symbols displayed on the slot machine wheels and use the symbols on the game wheels to modify (e.g., add, multiply, etc.) such awards, the play of the game (e.g., trigger a bonus game), or both. Additionally, the wheel can form winning combinations with the reel symbols and result in awards different than awards from winning combinations of reel symbols alone.

### Gaming Device Platform

The features and advantages of the gaming system and method described herein may be provided to a player via a gaming system that includes various structures and components for allowing player interaction with the gaming device. While only one gaming system will be described in detail herein, it is understood that the features, objects, and advantages of the gaming system described herein may be implemented in one or more alternative gaming systems.

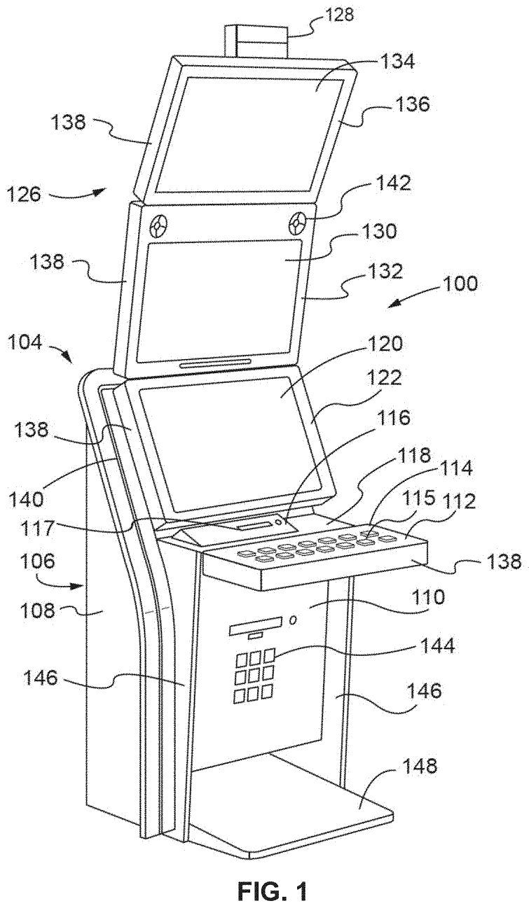

FIG. 1 shows a perspective view illustrating an example of gaming system 100 in accordance with aspects of the present disclosure. Such gaming system 100 may be referred to as a slot machine and, as illustrated, is housed in a cabinet 105 (e.g., a housing) constructed so that a player can operate and play the gaming system 100 while standing or sitting. The cabinet 105 can include a lower cabinet body portion 106, which includes a pair of cabinet side panels 108 (only one of which is viewable in the perspective view of FIG. 1), a front panel 110, and a rear panel (not shown). Additionally, a base panel (not shown) and a top panel surface (not shown) may support a first game display device 120 and the player interaction area 112. The cabinet panels 105, 106, 108, 110 (as well as the base panel and the top panel surface) may be interconnected along their edges and cooperate to form the cabinet 105, which encloses and houses components of the gaming system 100, as can be seen in FIG. 1. The cabinet 105 may function to securely protect local control system, technology components, and provide support for game display(s) and player input and output interactions with the gaming system 100, such as describe herein below.

While the example cabinet 105 is depicted as having a particular shape, structure, and organization, it should be appreciated that a wide variety of cabinet enclosure sizes, shapes, and designs are possible for the gaming system 100. For example, the cabinet panels 105, 106, 108, 110 (as well as the base panel and the top panel surface) may be combined into fewer elements or divided into additional elements. Additionally, the positions of the displays (e.g., first display device 120) and input/output devices can be reorganized and/or relocated with respect to one another.

In accordance with aspects of the present disclosure, a player can interact with the gaming system 100 in various ways to direct the wagering and game play activities and preferences. More specifically, the cabinet 105 includes input and output areas generally designated as the player interaction area 112. The player interaction area 112 may be located on the front top side of cabinet 105 and, as shown, on a panel structure that extends outwardly from the gaming system 100 in a player's direction. The player interaction area 112 may contain player input and output structures, including a player control area 114, a player value acceptor and dispenser area 116, and player convenience input area 118.

The player control area 114 includes one or more input devices 115, such as buttons and touch sensitive areas, through with which players may interact with the gaming system 100 so as to direct game play. It is expected that the cabinet 105 provides an easily accessible location and support for player input/output (I/O) interactions with the gaming system 100, including gaming control interactions and value wagering interactions. Although the gaming system 100 illustrated in FIG. 1 shows the input devices 115 of the player control area 114 as physical controls (e.g., buttons), it is understood that in some implementations, a player's gaming control interactions could be made by either the physical controls or functionally equivalent “soft” controls (e.g., soft buttons) located on the gaming display and activated by player touch (e.g., touch screen interfaces), or a combination of both arrangements.

The input devices 115 may include the following: game selection button(s) in any implementation where more than one game is provided in a single gaming system 100; gaming denomination value selection button(s) in any implementations where one or more wagering denomination value is accommodated; wager selection button(s) for the player to indicate or select the desired wager value for a game in any implementations where a selection of wager values are offered; pay line selection button(s) for selecting the number of active pay lines in game implementations that provide multiple pay line wagering; a reel spin button for players to initiate one or more reels to spin in a game; a repeat last bet button for players to conveniently repeat the last game's preference and wager selections in a new game; a cash-out button for player extraction of gaming device credits; an attendant call button; and gaming device information buttons such as show pay tables, show game rules, or show other game-related information.

The player value acceptor and dispenser area 116 may include one or more value acceptance and value distribution devices 117 that allow the player to interact with the gaming system 100 and to risk or otherwise place a wager (a monetary value) on one or more outcomes of a game. The value acceptance and value distribution devices 117 may return winnings to the player via some form of value distribution. In the player value acceptor and dispenser area 116, a player can supply monetary value to the gaming system 100 via the value acceptance and value distribution devices 117. In some implementations, the value acceptance and value distribution devices 117 may accept any one or more of the following from a player to establish a gaming credit balance: coins, bills, tokens, tickets/vouchers, player ID cards, credit cards, or other suitable forms of value. Thus, if the gaming system 100 accepts coins and bill, the value acceptance and value distribution devices 117 may comprise a currency bill validator and a coin validator. Likewise, if the gaming system 100 accepts tickets, the value acceptance and value distribution devices 117 may comprise a ticket acceptor that receives tickets or vouchers representing some monetary value. The ticket acceptor may include a bar code reader, or other appropriate code reader, for reading the encoded value contained by the player's ticket or voucher. In some implementations, value acceptance and value distribution devices 117 can accept more than one type of value. In some implementations, the player value acceptor and dispenser area 116 may include multiple different value acceptance and value distribution devices 117 that accept different types of value from players.

Upon receipt of some type of value from the player, the value acceptance and value distribution devices 117 of the player value acceptor and dispenser area 116 can perform validation on the player supplied value using appropriate hardware readers (e.g., determining that the currency bills/coins/tokens are genuine or the ticket/voucher is genuine). If the validation result is positive on player supplied value, the value acceptance and value distribution devices 117 can generate a signal to a processor of the gaming system 100 that establishes a gaming credit balance for playing one or more games on gaming system 100.

In some implementations, the value acceptance and value distribution devices 117 dispenses a monetary value, or a representation thereof, from the gaming system 100 when a player chooses to “cash out” the gaming credit balance (e.g., remove value from the gaming system 100). The player can cash out at any suitable time. When a player cashes out the value contained on a credit meter (not shown) of gaming system 100, a processor of gaming system 100 may cause a printer included in the value acceptance and value distribution devices 117 to print and dispense a coded ticket or voucher through a dispensing slot to the player. The coded ticket or voucher may be a bar-coded ticket or any other suitable code (PDF517 coding or quick response (QR) coding). This ticket can then be used as value input at another gaming device, or converted to currency at a conveniently located kiosk or cashier counter located near the gaming device. Alternatively, the processor of gaming system 100 may cause a currency bill dispenser or a coin dispenser included in the value acceptance and value distribution devices 117 to dispense the value contained on the credit meter of gaming system 100.

Various combinations of the above value acceptance and value distribution arrangements are possible. The gaming system 100 may include other value acceptance and value distribution mechanisms in the player value acceptor and dispenser area 116. For example, the value acceptance and value distribution devices 117 may include a magnetic strip or chip card reader/writer in order to accept value from and transfer value to a magnetic strip or an embedded chip card. In other implementations, the value acceptance and value distribution devices 117 may include hardware for transferring (and receiving) non-traditional currencies to players such as digital currencies (e.g., bitcoin).

In some implementations, the value acceptance and value distribution devices 117 may include a card reader that accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming system 100 may be associated with the player account. Additionally, a numeric or alphanumeric keypad (not shown) may be provided adjacent to the card reader slot that enables player entry of a personal identification number or the like for secure access to card information.

In some implementations, a player convenience input area 118 may be included in the gaming system 100, as is shown in FIG. 1. In various implementations, player convenience input area 118 may have a variety of features and functions depending on the jurisdictional deployment of the gaming system 100. In some implementations, the player convenience input area 118 may house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into the gaming system 100 during play. These player loyalty/players tracking cards may be associated with a player account and are utilized by the card-issuing entity to monitor, or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain implementations, the player convenience input area 118 may include player convenience features such as a pocket for storage that allows players to store their personal items such as a mobile phone. The gaming system 100 may include one or more universal serial bus (USB) ports that enables a player to charge their electronics or connect to services such as the Internet or food service. Further, player convenience input area 118 of the gaming system 100 may include buttons to request food or drink service if the gaming device is located in an establishment that has food and drink service. The gaming system 100 may be connected to a local or wide area network such that selection of the requested food or drink service may alert the establishment's hospitality staff to deliver the requested service directly to the gaming system 100.

The layout of the player control area 114, player value acceptor and dispenser area 116, and the player convenience input area 118 in gaming system 100 may be arranged differently than those disclosed and illustrated herein. The selections and arrangement of input locations on the cabinet 105 may be dependent upon the game buttons, the type of value wagered, and the player conveniences utilized in the deployment configuration of gaming system 100.

In some implementations, the lower cabinet body portion 106 includes the first game display device 120, which can be mounted atop or flush with a top panel surface of the lower cabinet body portion 106. The first game display device 120 can be, for example, a 27-inch liquid crystal display (LCD) display mounted in a widescreen orientation. However, any suitable display may be used in any suitable orientation. In the illustrated implementation, the first game display device 120 can mounted within and framed by first display frame 122 which is, in turn, mounted upon lower cabinet body portion's top panel surface. In this manner, the first game display device 120 is both surrounded and secured within the first display frame 122 and raised above the cabinet's top panel surface. Additional features of the first display frame 122 are described below. In some implementations, the gaming system 100 may use a single first game display device 120 and not include additional game displays (not illustrated). For example, a single first game display device 120 may span the one or more portions of the cabinet 105 (e.g., lower body cabinet portion 106 and upper body cabinet body portion 126, described below) in place of other display devices (e.g., display devices 130 and 134, described below).

The lower cabinet body portion 106 can be further constructed to support an upper cabinet portion 126. The upper cabinet portion 126 may be comprised of an upwardly extending support structure (not illustrated) that extends upwardly from the rear side of lower cabinet body portion 106 configured to mechanically support one or more additional game display devices.

At the topmost end of the support structure, a cabinet top light 128 may be provided. The cabinet top light 128 is capable of illumination in a variety of colors and is utilized to indicate and communicate conditions of the gaming system 100 to gaming players and service personnel.

Further, the upper cabinet portion support structure may conceal power and communication lines between (1) the control systems and components located within the lower cabinet body portion 106 and (2) the displays mounted on the upper cabinet portion 126 support structure.

In some implementations, as illustrated in FIG. 1, gaming system 100 includes additional displays, including a second game display device 130 and a third game display device 134. The second game display device 130 and the third game display device 134 can be disposed generally in a vertical relationship and generally in alignment with the first game display device 120. Like the first game display device 120, the second game display device 130 and the third game display device 134 can be 27-inch LCD displays and can be mounted in a widescreen orientation in some implementations. However, any suitable display in any suitable orientation may be used for the second game display device 130 and the third game display device 134. Further, like the first game display device 120, the second game display device 130 and the third game display device 134 can be mounted within and framed by second display frame 132 and third display frame 136, respectively. The second display frame 132 and the third display frame 136 can be attached to the upper cabinet support structure and can protect the second game display device 130 and the third game display device 134.

The first game display device 120, the second game display device 130, and the third game display device 134 can be disposed at an angle from each other to form a player-facing concave arc. However, in some implementations, the angles between the displays 120, 130, and 134 may be adjustable and may be smaller or greater than the angles illustrated in FIG. 1. Further, it is understood that in some implementations the displays may be disposed in a common plane relative to each other.

It also should be appreciated that in various implementations a variety of display technologies may be utilized equivalently and interchangeably with a variety of implementations of the gaming device. Equivalent display devices include all variations of liquid crystal displays, light emitting diode displays, and plasma displays.

In some implementations, different sized displays may be combined to display gaming data on gaming system 100. As a non-limiting example, a 27-inch widescreen LCD display may be combined with a 20-inch portrait-oriented LCD or a light emitting diode (LED) display. This combination may be used, for example, with a third scrolling banner LED display. In alternative implementations, one, two, three, or more displays could be used in a variety of positions and orientations. Any suitable combination may be used. It should also be appreciated that a processor of gaming system 100 may communicate with the disclosed first game display device 120, second game display device 130, and third game display device 134 through a video card of gaming system 100 to produce the visible aspects of a game.

In some implementations, one or more of the first game display device 120, the second game display device 130, and the third game display device 134 may be fitted with a transparent touch sensitive overlay for sensing player touch inputs into the gaming system 100. The touch sensitive overlays can communicate with a processor of gaming system 100 to enable the player to interact with the game.

In some implementations, the curved displays may be used for any or all of the first game display device 120, the second game display device 130, or the third game display device 134. Similarly, any of the displays used for gaming system 100 can be based on flexible display technologies. For example, it is possible to utilize flexible display technologies to create uniquely shaped curving, wavy, or tubular display structures to provide one or more of the first game display device 120, the second game display device 130, and the third game display device 134. Additionally, in some implementations flexible display technologies can be used in combination with fixed flat screen technologies.

While the gaming system 100 has been described as implemented with video technologies, in some implementations, mechanical reels with reel strips containing game indicia and step motor controllers may be employed to provide game information to a player. In some implementations, the reel strips may include printed symbols. In another implementation, the mechanical reels may include flexible video display technology as the reel strips on mechanical reels. Thus, games implemented in video form can readily be implemented with mechanical reels utilizing such display technology. Alternatively, in other implementations mechanical reels with reels strips having fixed symbols displayed along the reel strip could be used to implement the game.

Dependent upon the particular gaming device housing style, a variety of other display technologies may be utilized in combination with the gaming device disclosed herein. For example, the gaming system 100 may have one or more display devices in addition to the main game display devices(s) in some implementations. For example, the gaming system 100 may include a player tracking device having a player tracking display which displays various information to the player regarding the player's status. The gaming system 100 may also include other game-related displays such as the wager display and the gaming credit balance display. These additional game-related displays may be separate display devices or may be displayed on any one or more of the first game display device 120, the second game display device 130, or the third game display device 134.

The gaming system 100 may also include cabinet lighting design functions to attract players. In the example gaming system 100 illustrated in FIG. 1, attractive cabinet lighting is provided by frame accent lighting 138. It is noted that frame accent lighting 138 is a common structure found on the first display frame 122, the second display frame 132, and the third display frame 136 and player interaction area 112. Example areas where frame accent lighting is applied to the gaming system 100 are commonly designated as frame accent lighting 138.

Frame accent lighting 138 may have multiple components. The side edge pieces of first display frame 122, second display frame 132, third display frame 136, and the edge structure of player interaction area 112 can be made of a translucent or transparent plastic or other suitable materials. Linear arrays, or strips, of light emitting diodes (LEDs) (not shown) on circuit boards may be mounted below the translucent or transparent plastic side edge pieces 138. In some implementations, the circuit boards are flexible circuit boards. These LED strips and transparent or translucent coverings may surround one or more gaming device displays frames, as well as the player interaction area, to highlight these areas.

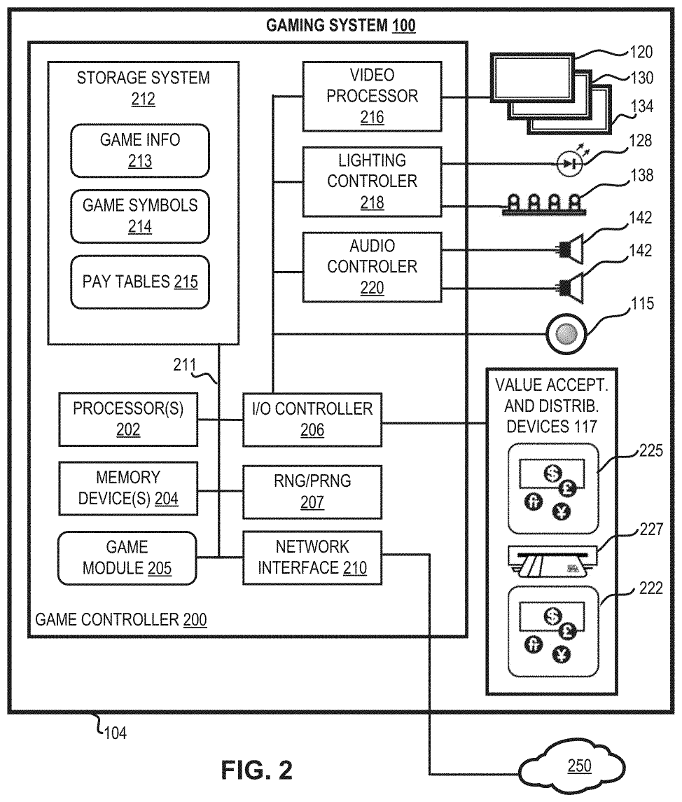

In some implementations, the individual LEDs mounted on the LED strips are of a type that can emit red, green, and blue light. In an alternative implementation, separate LEDs are used for the light colors. All LED strips can be electrically connected and can be controlled by a cabinet lighting controller (e.g., cabinet lighting controller 218 in FIG. 2) in conjunction with a processor of the gaming system 100 to selectively mix the emitted light colors in a manner to create any color. The cabinet lighting controller can flash and vary lighting as desired. For example, cabinet edge lighting can change and flash in combination with music rhythms or in combination with game events. Other variations are possible.

In some implementations, cabinet 105 may include LED strip lighting or LED rope lighting to accentuate the cabinet and enhance the attractiveness of the gaming system 100 to players. LED rope lighting is a number of small light-emitting diode bulbs linked together and encased in a plastic, polyvinylchloride, or other suitable material to create a string of lights. For example, in one implementation illustrated in FIG. 1, cabinet 105 includes cabinet accent lighting 150. In some implementations, cabinet accent lighting 150 is LED rope lighting mounted flush with the front side edge of the cabinet side panels 108. The LED rope lighting can generate any of suitable colors, and are controlled by cabinet lighting controller and a processor of gaming system 100 to selectively mix the emitted light colors in a manner to create any color in the same manner as the frame edge lighting.

In various implementations, gaming system 100 includes one or more audio speakers 152 and appropriate driving electronics and sound cards so that game players may experience pleasing audio aspects of the gaming system 100. Audio is desirable to attract and maintain player interest in gaming system 100. The gaming system 100 may also emit attraction sounds during any idle period of gaming system 100. Game audio may add to the player's enjoyment of gaming system 100 by providing music and sound effects designed to enhance and compliment the gaming experience. In FIG. 1, the audio speakers 152 are shown mounted on the upper corners of second display frame 132. Any suitable number of additional audio speakers 152 may be provided on additional display frames or on the lower cabinet body portion 106 as desired.

The audio speakers 152 designed for emitting bass vibrations may be included in some implementations. Placement of the audio speakers 152 may be selected to enhance the sound emitting characteristics of the gaming system 100. For example, bass speakers or additional speakers 155 may be mounted inside lower cabinet body portion 106. Further, it is envisioned that in some implementations sound processing such as multichannel processing and surround sound processing are included in gaming system 100. Audio jacks for attachment of player headphones may also be provided in some implementations of gaming system 100 for the player to further enhance the audio experience of the game and also to block out noise from other gaming devices.

In some implementations, the front panel 110 of lower cabinet body portion 106 includes a locked removable panel or locked door (not shown), which can be opened for access to internal control system and technology components that are housed within lower cabinet body portion 106 (discussed hereinbelow with respect to FIG. 2). Front panel 110 may be flanked on vertical sides by cabinet side panel extensions 156 which serve to define a space below player interaction area 112 for players to place their feet and legs while they are playing the gaming system 100 in a seated position. Foot rest 158, which may be cushioned, is provided below player interaction area 112 to enhance a player's ergonomic comfort while playing the gaming system 100. In some implementations, the edges of player interaction area 112 may be ergonomically cushioned as well.

The gaming system 100 may be embodied in alternative gaming device housing forms and styles. For example, the housing may have fewer or greater number of display areas for displaying the game and game-related information to the player. If multiple displays are used, the displays may be of similar size, shape, and orientation or the displays may be divergent from each other in one or more of their respective descriptive characteristics. The one or more displays can be supported by, mounted upon, or housed within a cabinet 105 which can comprise a variety of shapes, sizes, and forms. The cabinet 105 can 1) protect and house the operational electronics, 2) adequately support the display(s) in a position easily viewable for a seated or standing player, as necessary, and/or 3) provide an easy location and support for all necessary player input/output (I/O) interactions, including gaming control interactions and value wagering interactions. For example, in some implementations the gaming system 100 may be disposed in a housing style referred to as a “slant top” gaming device that is designed to be operated with the player comfortably seated. In this arrangement, generally, the gaming display(s) and all player I/O controls are located on a low, wide, surface that extends forwardly from the player on a horizontal plane and then slopes upwardly and away from the player's seated location.

In some implementations, housing styles of cabinet 105 of gaming system 100 may include bar top or table top housing arrangements. These housings are generally small enough to be placed on top of an existing bar or table while providing the requisite gaming device housing functions of protection of/access to gaming electronics, displays, and player I/O functions described above.

In some implementations, cabinet 105 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

FIG. 2 shows a functional block diagram illustrating an example of a game controller 200 of a gaming system 100 in accordance with aspects of the present disclosure. The gaming system 100 can include a cabinet 104, one or more player input devices 115, one or more value acceptance and distribution devices 117, one or more display devices 120, 130, and 134, a cabinet top light 128, accent lighting 138, and one or more audio speakers 152, which can be the same or similar to that previously described herein. Additionally, implementations of the game controller 200 includes one or more processors 202, one or more memory devices 204 (e.g., random access memory and read only memory), a game module 205, an input/output (I/O) controller 206, a random number generator 207, a network interface 210, a communication channel 211 (e.g., a data bus), a video processor 216, a lighting controller 218, and an audio controller 220. In accordance with aspects of the present disclosure, the game controller 200 is configured to perform specialized game functions and operations, consistent with the embodiments described herein. The functional elements shown in FIG. 2 cooperate, on a broad and general level, to function as a gaming system providing the functionality and operations detailed below. Such functionality and operations can be embodied in hardware, software, or a combination thereof. It is understood that the below described hardware includes the structures described, as well as the functional or operational equivalents of such structures. Further, it is understood that the below-described functions can be performed by hardware, digital circuitry, computer software, computer firmware, or functionally equivalent combinations thereof.

The processor 202 can be one or more general-purpose processors, special-purpose processors, or other programmable data processing apparatuses providing the functionality and operations detailed herein. In some implementations, the processor 202 is specially configured with arithmetic logic units and math co-processors, also known as floating point units, for performing the gaming consistent with the various implementations disclosed herein. In some implementations, the processor 202 includes registers for holding instructions or other data, and cache memory for storing data for faster operation thereupon.

A controller, in some implementations, is a device or a software program that manages or directs the flow of data between two entities. Often, controllers are special purpose circuitry or software that solve a technical communications problem between different technology systems. In some implementations, a controller functions as an interface between two systems while managing the communications between the systems. In another implementation, a controller functions as an interface between a processor and a peripheral device and functions to control the peripheral device.

The memory device 204 can be operatively and communicatively connected to the processor 202. In some implementations, the memory device 204 includes one or more types of memory structures. For example, the memory structures can include random access memory (RAMs) units, read only memory (ROMs), flash memory (e.g., solid state drives (SSDs)), and electrically erasable/programmable read only memory (EEPROMs). It should be appreciated that in some implementations, communication with the memory device 204 by the processor 202 or a controller, encompasses the processor or controller accessing the memory device 204, exchanging data with the memory device 204, or storing data to the memory device 204.

The memory device 204 may store program code, game code (collectively the “code” or “program instructions,” such as game module 205), and operational data (e.g., game info 213, game symbols 214, and pay tables 215) used in the operations of the game controller 200 to provide a gaming system that executes the gaming functions described hereinbelow. In an alternative implementation, the code and operational data for the operation of the game controller 200 may be stored in a distributed manner such that some code is stored in memory device 204 (or storage system 212) and other code is stored remotely from the game controller 200. In some implementations, the code and operational data used the operation of the game controller 200 includes, for example, basic input and output function data, instruction fetching data, bus and network communication protocol data, and like data for an operational gaming device. In some implementations, the code (e.g., game module 205) and operational data (e.g., game info 213, game symbols 214, and pay tables 215) used for the execution of the gaming features includes, for example, game image data, game rule data, pay table data, game mode and timing data, gaming value and wager parameter data, and random or pseudo-random number generation data.

In addition to the memory device 204 described above, in some implementations, the code and operation data for the operation of the gaming device described above may be stored in storage system 212. The storage system 212 can be removable game cartridges or flash drives, a compact disk ROM, a digital versatile disk (DVD) optical storage technology, or suitable other fixed non-transitory storage devices. In another implementation, part or all of the code and operational data for operation of the gaming device or for execution of the game features may be stored in a remote memory structure and be downloaded to the memory device 204 via a network connection.

In some implementations, the game controller 200 may utilize any combination of memory devices such as random-access memory devices (RAMs), unalterable memory devices (ROMs), and mass storage devices for securely storing and securely communicating the software components or code that facilitate game play and other functions of the game controller 200. The memory devices may store software components or code that include various game data and game related control and execution software. In some implementations, the software components stored in the memory devices 204 may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the game controller 200.

In some implementations, memory devices, such as memory device 204 and storage system 212, with the software components and other data may be secured and authenticated by authentication software stored in an unalterable memory device within the housing of the game controller 200. The game controller 200 may also include application specific integrated circuits (ASICs) to perform the security and authentication functions. At various time or events, such as before each play of a game, at a predetermined interval, upon transfer of any game data or any software components from a mass storage to the memory device 204, or upon demand, the game controller 200 (using a processor such as processor 202 or a separate ASIC) may execute an authentication routine and perform an authentication of any software component or other data of the game controller 200. In some implementations, the gaming device software components may be prepared for authentication via creation and storage of an encrypted signature unique to one or more of the software components.

In some implementations, an encrypted signature may be created by utilizing a hash function on a software component or code to form a message digest (i.e., a hash of the software component) followed by a key encryption of the message digest to form an encrypted signature unique to the software component. In some implementations, the key encryption may be public key encryption, private key encryption, or any suitable key encryption schema. The encrypted signature may be stored with the gaming device software component, for example, in a mass storage device or an unalterable memory. During a software component authentication, the gaming system 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and the game controller 200 may allow game play to proceed. However, when the message digests do not match, the game controller 200 may determine that the software component under authentication may be corrupted or fraudulent and game play may be halted. It should be appreciated that the game controller 200 may perform other suitable security and authentication checks on the game data or software components. Such authentication and security devices and functions are unique to gaming and casino industry to minimize or prevent fraud in gaming devices and gaming systems.

For a player to interact with a gaming device, the game controller 200 receives and processes player inputs from, e.g., input device 115, and the game controller 200 causes processed results to be output or communicated to the player. In some implementations, player inputs are recognized and processed or directed for processing by input/output (I/O) controller 206. Further, I/O controller 206 may process and direct player outputs for communication to the player. The I/O controller 206 can function as the intermediary between the processor 202 and one or more input devices to control information and data flow therebetween. I/O controller 206 may also function as the intermediary between the processor 202 and one or more output devices to control information and data flow therebetween. I/O controller 206 is configured to understand the communication and operational details (such as hardware addresses) for the attached input devices and output devices. In this manner, processor 202 is freed from the operational details of the peripheral I/O devices. For example, in some implementations where an input or output device is changed or upgraded, the I/O controller 206 can be changed without changing other gaming system components.

In some implementations, a player deposits value into a gaming device by inserting some form of currency into a value acceptor 225 for game play. Alternatively, a player deposits value into a gaming device by inserting an encoded paper ticket into a value acceptor 225 for game play in some implementations. The value acceptor 225 can be combined with a currency reader and validator, and a code reader for reading value encoded on paper tickets. The value acceptor 225 may read, validate and communicate the amount of the inserted value to the processor 202. The processor 202 can establish a gaming credit balance for the player based on the communication from the value acceptor 225. Processor 202 can also communicate the player's credit balance on a credit balance display of gaming system 100. During game play, the processor 202 processes a player's wagers and determines the amount of credits to debit from the player's credit balance. When a winning outcome is obtained, the processor 202 is configured to determine the amount of credits to add to the player's credit balance.

As previously mentioned with respect to FIG. 1, a variety of value acceptance arrangements are possible. In some implementations, the value acceptor 225 could include magnetic strip or chip card readers to accept and transfer value. The value acceptor 225 may also be configured to accept and transfer non-traditional currencies such as digital currencies. In these implementations, I/O controller 206, a processor 202, or both contain appropriate control instructions to communicate and extract value from the inserted item containing value. In some implementations, use of a magnetic strip or embedded chip card, for example a bank card, for value insertion requires the processor 202 to communicate, via network interface 210 (described below), with devices external to a gaming device.

In some implementations, a card reader 227 may be included in gaming system 100 to accept player loyalty cards. For example, card reader 227 can extract account identifying information from the card and utilizes this information to access the associated account information stored remotely via network interface 210. In implementations where player loyalty/player tracking systems are employed, a player's loyalty account and record of gaming activity can be stored in a networked storage location or database. The processor 202 is configured to record the player's gaming activity in memory device 204 during the duration of loyalty card insertion. When the loyalty card is removed from card reader 210, recorded gaming activity is uploaded, via network interface 210, to the remote storage location associated with the player's account. In this manner, the player's gaming activity can be further processed and analyzed, and the player can be awarded loyalty rewards based upon his activity data.

In various implementations, an input device 115 receives a player's game inputs and communicates the player's game inputs to the processor 202. The player's game inputs may include, but are not limited to, wager amounts, pay line selections, game control signals, and cash-out signals. The input device 115 may generate signals based on button presses, touch screen activations, or voice control. The player-initiated signals are propagated to the processor 202 by the I/O controller 206. Further, the player-initiated signals may direct and inform execution of the game instructions stored in the memory device 204 and configured to be executed by the processor 202.

In some implementations, the processor 202 is configured to execute stored program code and instructions which generate random numbers or pseudo-random numbers. In some implementations, as illustrated in FIG. 2, a random number generator (RNG) 207 is a software module configured to be executed by the processor 202 for the generation of a true random or pseudo-random number. The code for RNG 207 may be stored in the memory device 204 or the storage system 212. The RNG 207 generates random numbers for use by the gaming software during game execution. In some implementations, random numbers are utilized by game software for the random selection of one or more game symbols from a set of game symbols during a game. As a non-limiting example, the set of game symbols can include numbers, letters, geometric figures, symbols, images, character, animations, blank symbols (e.g., the absence of symbols), or any other suitable graphical depiction. In various implementations, once random symbols are selected based upon the random number generated by the RNG 207, patterns of symbols are compared to determine wagering outcomes. In an alternative implementation, gaming system 100 may include a hardware based random number generator that is in communication with processor 202 to supply random numbers for game generation purposes. The hardware based random number generator may be incorporated into processor 202 or can be separate from processor 202.

In yet another implementation, the random generation of “numbers” or symbols may be performed with electro-mechanical components. For example, gaming devices such as gaming system 100 may incorporate mechanical reels rotatable about a common axis. Indicia or symbols may be positioned around the periphery of the reels. The indicia or symbols on the reels may indicate separate detectable reel stop positions. The reels can be set into a spinning/rotation motion by pulling a lever or pushing a button. In some implementations, the gaming system 100 can stop the reels by a gaming device actuating, on a random timing basis, a suitable mechanical or electro-mechanical reel brake. When the reels stop rotating, one or more displayed stop positions of the reels are detected. Since the stop positions are associated with respective indicia or symbols, the gaming device can determine whether the combination of stop positions (i.e., translating to a combination of displayed symbols) results in a winning symbol combination.

Returning to FIG. 2, the game controller 200 controls the function and output of output devices utilized by a gaming device. In various implementations, I/O controller 206 serves as an interface unit between processor 202 and output devices, such as video processor 216, cabinet lighting controller 218, audio controller 220, and value dispenser 222.

In some implementations, the video processor 216 communicates with processor 202 to render all game graphics, video displays, and information on one or more video display units (e.g., displays 120, 130, and 134). In some implementations, the video processor 216 includes one or more processors, controllers, and/or graphics cards for processing the game images, outcomes, and animated displays and coordinating the processed data to be display between, among, or across any or all display devices. In various implementations, this may include being configured to simulate objects and the movement of objects which represent video reels containing sets of gaming symbols.

It should be appreciated that in certain other implementations where physical mechanical reels are utilized by the gaming system 100 as a game displays, reel controllers and stepper motors would be provided in lieu of or in addition to video processor 216.

In implementations which utilize cabinet lighting as described with respect to FIG. 1, a cabinet lighting controller 218 may be utilized to coordinate and control the color and timing of cabinet lighting displays with processor 202. In certain implementations which utilize sound design, processor 202 may utilize audio controller 220 to coordinate and control the sound emissions. In some implementations, audio controller 220 may include one or more audio processing cards for generating sound and for driving the one, two or more speakers 142 that may be included with a gaming device.

In various implementations, players may request the remaining credit value by making a request or initiating a signal via input device 115 which is communicated to processor 202 via I/O controller 206. The signal triggers a readout of the player's credit amount and processor 202 initiates a value dispensing signal which, in turn, is communicated to value dispenser 222. In some implementations, value dispenser 222 can be controlled to issue the player's credit value using any of the types of value discussed herein. In some implementations, the player's credit value may be issued to the player via a printed and dispensed encoded paper ticket or token which the player can then exchange at a special purpose kiosk or cashier location for the monetary value encoded into the ticket or token. In some implementations, the processor 202 can direct the value dispenser 222 to issue to the player an appropriate amount of coin or bills directly to the player. Additionally, or alternatively, in some implementations, the player may have the option to electronically direct the credit value to an account associated with the player.

In some implementations, the game controller 200 may communicate with one or more devices outside the gaming device. For example, gaming system 100 may be connected to a larger network 250 via a local area network (LAN) or a wide area network (WAN). The game controller 200 may communicate with one or more central servers, controllers, or remote devices to execute games, establish credit balances, participate in jackpots, etc. In such implementations, network communications and connections are accomplished via a network interface 210. Network interface 210 can be a digital circuit board or card installed in game controller 200 to provide network communications with external devices.

In some implementations, various additional features and functions are performed by the game controller 200. For example, the game controller 200 may be specially configured with software to track all game play events that occur on a gaming device. In some implementations, the game controller 200 may audit all recorded monetary transactions, including all wager amounts, game outcomes, game winnings, and game payouts that occur through the value dispenser 222. Further, some implementations may include security software to assist in protecting the gaming system 100 from tamper or alteration attempts.

### Gaming System Operation

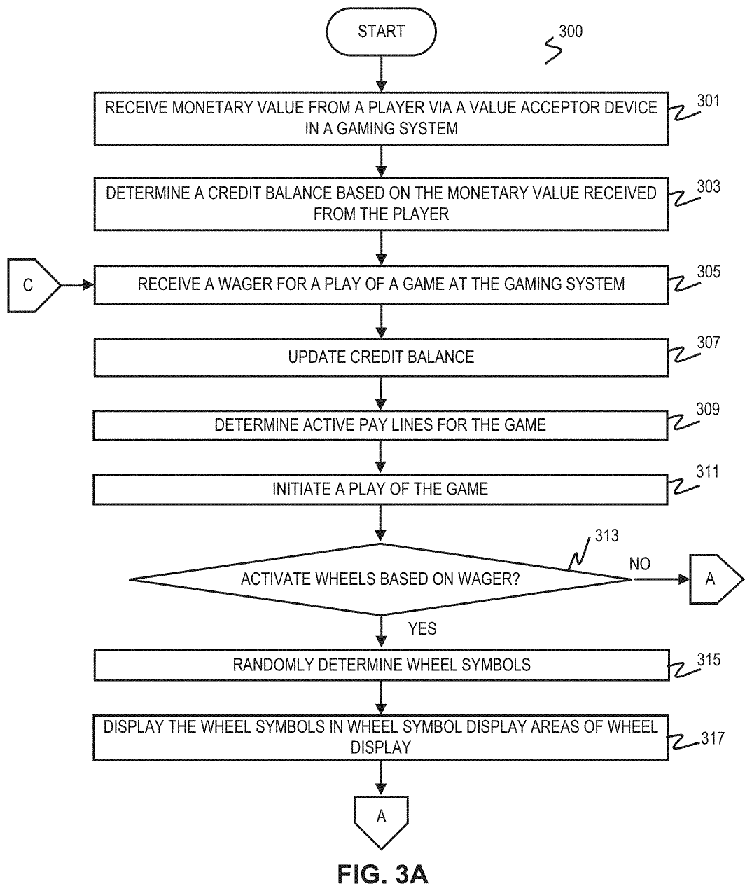

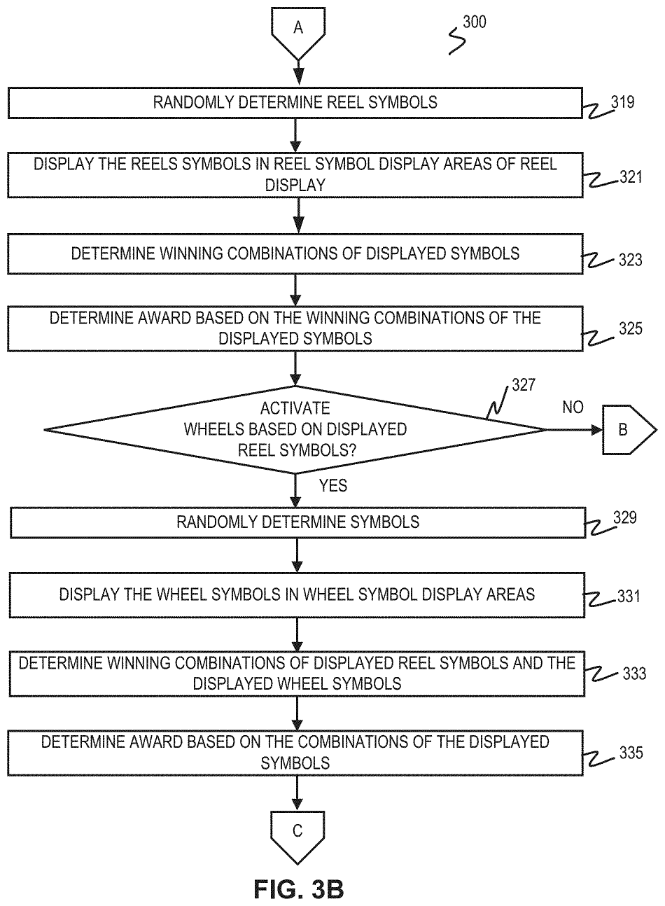

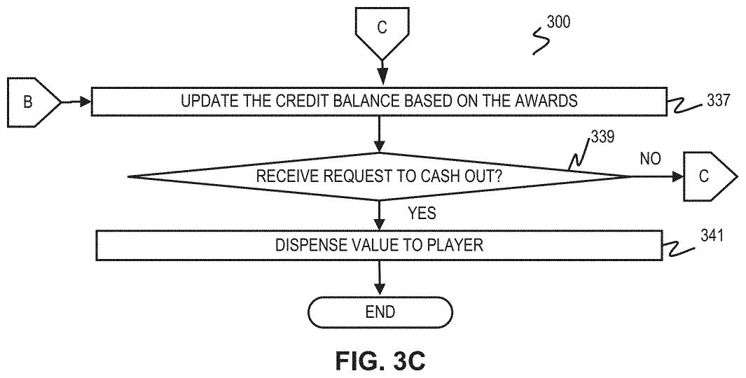

The flow diagrams in FIGS. 3A-3C illustrate functionality and operations of systems, devices, processes, and computer program products according to various implementations of the present disclosure. Each block in FIGS. 3A-3C can represent a module, segment, or portion of program instructions, which includes one or more computer executable instructions for implementing the illustrated functions and operations. In some implementations, the functions and/or operations illustrated in a particular block of the flow diagrams can occur out of the order shown in FIGS. 3A-3C. For example, two blocks shown in succession can be executed substantially concurrently, or the blocks can sometimes be executed in the reverse order, depending upon the functionality involved. Additionally, in some implementations, the blocks of the flow diagrams can be rearranged in different orders. Further, in some implementations, the flow diagram can include fewer blocks or additional blocks. It is also noted that each block of the flow diagrams and combinations of blocks in the flow diagrams can be implemented by special-purpose hardware-based systems that perform the specified functions or acts, or combinations of special-purpose hardware and computer instructions.

FIGS. 3A-3C show a process flowchart illustrating an example of a method 300 of operating a gaming system (e.g., gaming system 100) in accordance with aspects of the present disclosure. FIGS. 3A-3C describe parts of a base or primary game. However, it is understood that FIGS. 3A-3C may be integrated as part of a bonus game provided from a base or primary game. In some implementations, one or more processors (e.g., processor 202) of the gaming system are configured, via instructions (e.g., gaming module 205) stored in a memory device (e.g., memory 204 or storage system 212) to perform the method 300.

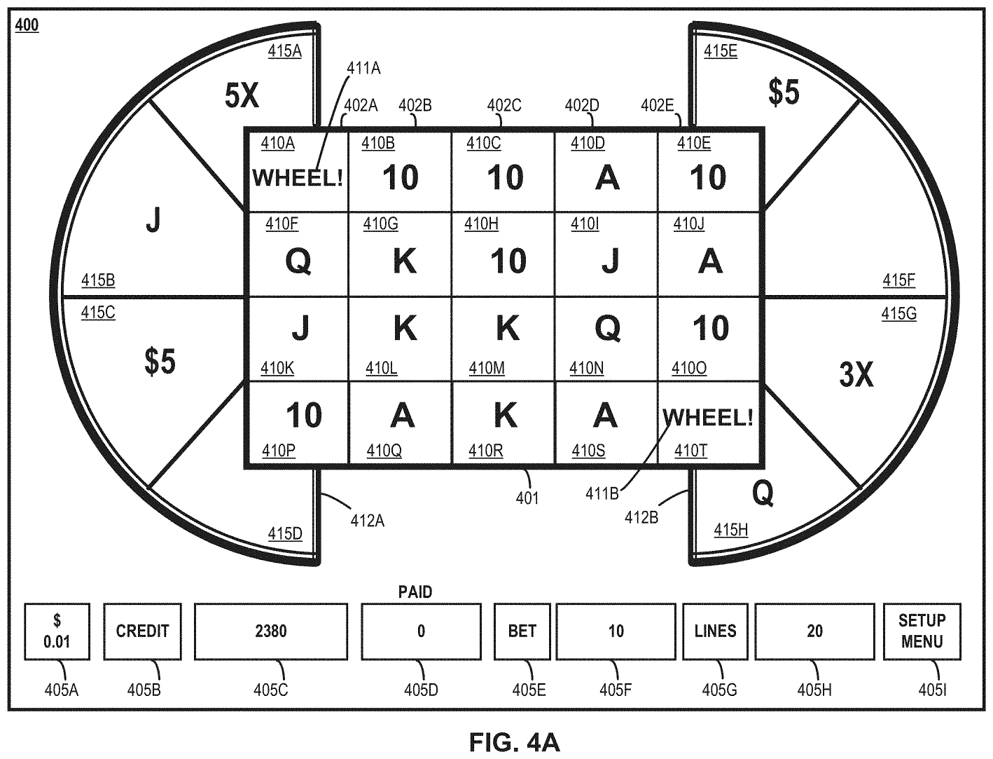

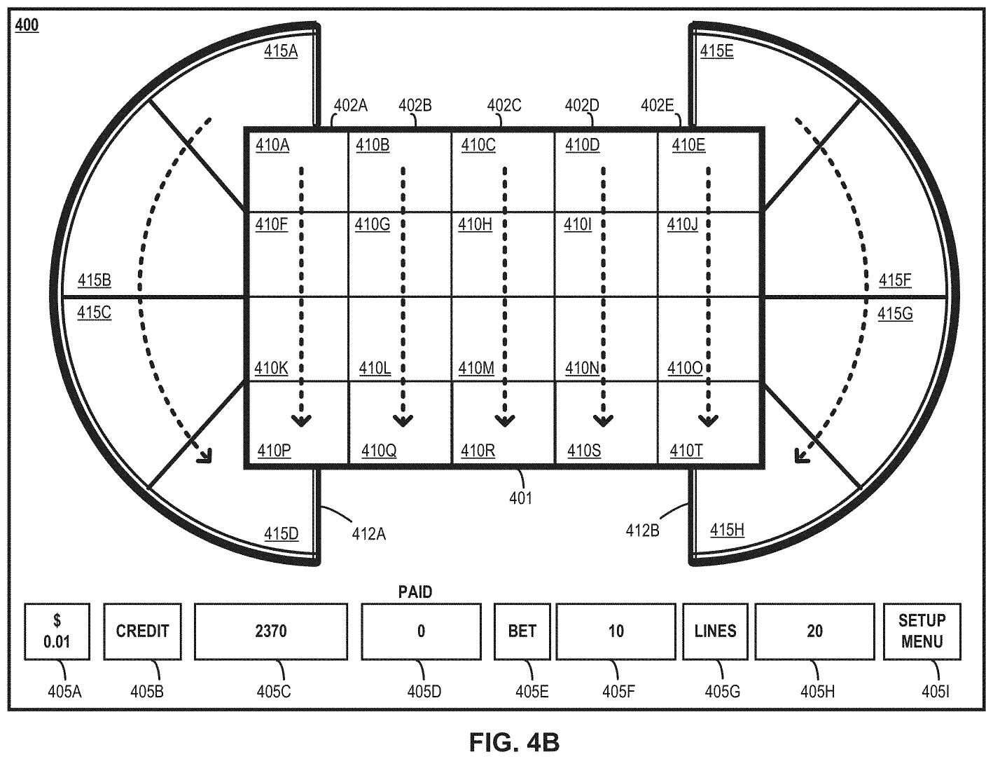

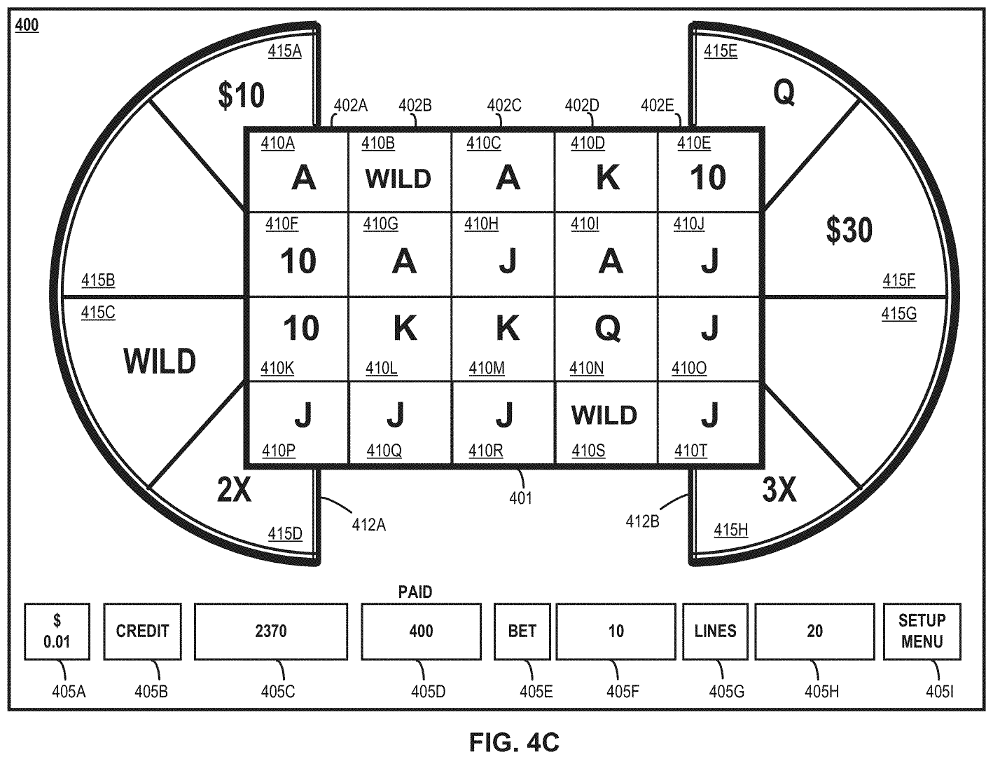

As described above and as set forth in greater detail below, the present disclosure provides a process for operating a gaming system that combines displays from different types of games. In implementations, the gaming system displays a game including game reels that can function in co-operation with one or more game wheels. The game wheels can be a circular shapes or partial circular shapes (e.g., half-wheels) segmented into a number of arc wedges comprising a circular array of wheel symbol display areas. The game reels can form a rectangular array comprising a number of reel symbol display areas. One or more of the wheel symbol display areas of the game wheels can be aligned with a one or more rows of the game reels. For example, as illustrated in FIGS. 4A-4C, a game screen (e.g., game screen 400) of a gaming system can include a game reel display (e.g., game reel display 401) comprised of five (5) game reels (e.g., game reels 402A-402E) vertically aligned so as to provide a rectangular array comprising four (4) horizontal rows of reel symbol display areas (reel symbol display areas 410A-410E, 410F-410J, 410K-410O, and 410P-410T). The game screen can also include a first game wheel (e.g., game reel 412A) having wheel symbol display areas (e.g., wheel symbol display areas 415A-415D) visibly aligned with the four horizontal rows at a leftmost reel (e.g., game reel 402A) of the reel display. Additionally or alternatively, the game screen can include a game wheel (e.g., game reel 412B) having wheel symbol display areas (e.g., wheel symbol display areas 415E-415H) visably aligned with the four horizontal rows at a rightmost reel (e.g., game reel 402E) of the reel display. In some implementations, the wheel symbol display areas are arranged so as to be adjacent to or adjoin with respective reel symbol display areas. Accordingly, the wheel symbol display areas may align with one or more paylines of the game reels. For example, wheel symbol display areas 415A, 415B, 415C, 415D can align horizontal paylines running through with reel symbol display areas 410A-410E, 410F-410J, 410K-410O, and 410P-410T, respectively. The gaming system can, therefore, determine awards for the game based on winning combinations of symbols displayed on the game reels and use the symbols on the game wheels to modify (e.g., add, multiply, etc.) such awards, the play of the game, or both. Additionally, symbols displayed on the game wheels can function as additional symbols that can form winning combinations with the reel symbols and result in awards different than awards from winning combinations of reel symbols alone.

Turning to block 301 in FIG. 3A, the gaming system (e.g., gaming system 100) performing the method 300 receives a monetary value via a value acceptor device (e.g., value acceptor 225). In block 303, the gaming system determines a credit balance based on the monetary value received in block 301. In block 305, the gaming system receives a wager for a play of a game from a player via an input device (e.g., input device 115) using, e.g., the credit balance determined at block 303. In some implementations, the gaming system allows the player to place a minimum wager, a maximum wager, or other wager therebetween. In some implementations, an amount of the wager determines the value of some of the awards available from the game. Additionally, In some implementations, an amount of the wager may determine whether the game will use one or both game wheels. In some implementations, the gaming system determines whether the credit balance determined at block 303 includes enough credits to enable the wager received at block 305. The gaming system may prevent the player from placing the wager and initiating a play of a game if the player's credit balance is not large enough to support the wager. If enough credits are not available in the player's credit balance, the gaming system may provide the player with an option to insert additional value to obtain the minimum credit level or to cash out of the gaming system.

In some implementations, a play of a game begins with the wager at block 305 or initiation of the game at 311, and the play of the game ends when evaluation and display of all symbol sets are complete (e.g., block 335). In another implementation, one play of a game comprises the processor executing blocks 305-335. In some implementations, block 339 and block 341 are not part of a play of a game. In alternative implementations, block 339 and block 341 are part of a play of a game.

At block 307, the gaming system updates the credit balance determined at 303. In some implementations, the credit balance is updated based on the amount of the wager received at 305. It is understood that some implementations of the method 300 may not include block 307 and that the gaming system may update player's credit balance at other times (e.g., at block 337), such as at the completion of the game.

At block 309, the gaming system determines active pay lines (a.k.a., wagered pay lines) for the game. In some implementations, depending on the amount of the wager received at block 305, the gaming system enables the player to select particular pay lines across reel symbol positions displayed in a game screen (e.g., reel symbol display areas 410 on reels 402 of game screen 400 in FIG. 4A). Although in some implementations, the gaming system selects the active pay lines automatically based on the wager received at block 305. In is understood that some implementations of the gaming system may not include pay lines and, as such, the method 300 may not perform block 309. For example, the gaming system may use ways pays (e.g., all-ways pays) as an alternative to pay lines. It is further understood that some implementation may use such ways-pays in combination with the active pay lines determined at block 309.

At block 311, the gaming device initiates a play of the game. The initiation can be automatically triggered in response to the wager at block 305 or it can be manually triggered in response to receiving an input via an input device. For example, the player may press a spin button on the gaming system (e.g., input device 115) to start spinning the game reels (e.g., reels 402 in FIGS. 4A-4C) and the game wheels (e.g., game wheels 412 in FIGS. 4A-4C) of the gaming system (or randomly generating symbols using other methods) for the play of the game. Additionally, the player may press the same spin button or a different rotate button to start rotation of the game wheels separately from the game reels of the gaming system.

At block 313, the gaming system determines whether to activate one or more of the game wheels for the game based on the wager received at block 305. As noted above with regard to block 305, in some implementations, activation of the game wheels may be conditional based on the wager received from the player. In some implementations, an amount of the player's wager may determine whether the game will use one or both game wheels (e.g., game wheels 412A, 412B). For example, in some implementations, a minimum wager or side bet may activate one of the game wheels, whereas a maximum wager or side bet may activate both game wheels. It is understood that other wager amounts may be chosen to activate one or both game wheels. It is also understood that, in some implementations, the method 300 may not include block 313, such that one or both game reels are activated regardless of the wager received at 305.

If the gaming system determines not to activate the one or more game wheels (e.g., block 313 is “No”), then the method advances to block 319 in FIG. 3B via off-page connector “A,” as described below. On the other hand, if the gaming system determines to activate the one or more game wheels (e.g., block 313 is “Yes”), then at block 315, the gaming system randomly determines, using a random number generator (e.g., random number generator 207), wheel symbols for the game from one or more sets of symbols. In implementations in which the game wheels are rendered using a video display (e.g., display 130), the random number generator can be used to select the wheel symbols from the one or more sets. As non-limiting examples, the sets of symbols can include graphical symbology depicting numbers, letters, geometric figures, poker cards, images, characters, animations, blanks (e.g., the absence of symbols), or the like. Additionally, the sets of symbols may include modifier symbols, such as pay symbols (e.g., a cash award added to an awards of a winning combination) and multiplier symbols (e.g., a 10X increase in an award of a winning combination). Further, the sets of reel symbols may include special or designated symbols (e.g., wild symbols, trigger symbols, scatter symbols, collectable symbols, free game symbols, etc.). In some implementations, types of reel symbols included in the sets may be different. A first set may include poker symbols, a second set may include “wild” symbols (e.g., Joker symbols), and/or a third set may include triggers symbols that can trigger a bonus game or bonus feature. While the game wheels are described above are described as being rendered by a video display, it is understood that some implementations may instead use electro-mechanical wheels where, using the random number generator, the gaming system controls mechanical wheels to select symbols by physically rotating to a randomly-selected stop position.

At block 317, the gaming system causes the display device to display the wheel symbols determined at block 315. For example, in some implementations in which the wheels are rendered using a video display, the gaming system may populate all visible wheel symbol display areas (e.g., wheel symbol display areas 415A-415H in FIGS. 4A-4C) displayed by the one or more wheels (e.g., wheels 412) displayed in the game screen using the wheel symbols determined at block 317.

Turning to FIG. 3B, as indicated by off-page connector “A,” at block 319 the gaming system randomly determines, using the random number generator, reel symbols for the game reels from one or more sets of symbols in a same or similar manner to that described above with regard to block 315. In implementations in which the game reels are rendered using the video display, the random number generator can be used to select the reel symbols from the one or more sets. The sets of symbols may be the same or similar to the sets of reels symbols used at block 313. For example, the symbols can be selected from one or more sets including graphic symbology, pay symbols, modifier symbols, special symbols or designated symbols. While the game reels are described above in terms of a video display, it is understood that some implementations may instead using electro-mechanical reels, where the gaming system controls mechanical reels to select symbols by physically rotating to a randomly-selected stop position. At block 321, the gaming system causes a display device (e.g., first display device 120) to display the reel symbols determined at block 319. For example, in some implementations in which the reels are rendered using a video display, the gaming system may populate all the visible reel symbol display areas (e.g., reel symbol display areas 410A-410T in FIGS. 4A-4C) displayed by one or more game reels (e.g., reels 412A and 412B) of a reel display (e.g., reel display 401) displayed in a game screen (e.g., game screen 400) using the reel symbols determined at block 319.

While the determination and display of the wheel symbols and reel symbols at blocks 317-319 are described separately, it is understood that such functionality can be provided in the same, different, or overlapping time frames. For example, initiating the play of the game at 315 may cause both the reels to spin and the one or more wheels to rotate at substantially the same time.

At block 323, the gaming system determines winning symbol combinations of the symbols displayed in the reel symbol display areas at block 321 of the game reels. Additionally, if the one or more game wheels were activated at block 313, determining winning symbol combinations includes determining winning symbol combinations of the symbols displayed by the game wheels and the game reels at blocks 317 and 321. At block 325, the gaming system determines an award based on the winning symbol combinations determined at block 323, as well as any additional award symbols displayed in the active paylines. In some implementations, the gaming system only evaluates the symbols displayed across active or wagered pay lines determined at block 309 for winning symbol combinations at block 325. For example, a pay table (e.g., pay table 215) associated with the gaming system may indicate that a sequence of at least three of the same symbols (when evaluated left-to-right, right-to-left, and/or scattered) is a winning symbol combination and awards a predetermined payout. Accordingly, the gaming system would evaluate the generated symbols for such sequence of symbols (e.g., three Ace (“A”) symbols). If the gaming system generated at least three symbols in a sequence along an active pay line on adjacent symbol display areas of the reels or the wheels, the gaming system may determine that the three symbols is a winning symbol combination based on the predetermined pay table.

While the present example describes a sequence of three symbols, it is understood that the pay table may correlate various winning symbol combinations to payouts. In some implementations, the pay table may indicate that as few as one symbol may be associated with a payout. Alternatively, two or more symbols may be used to form winning symbol combinations that result in a payout. Further, in accordance with aspects of the present disclosure, the determination of the winning symbol combinations can include symbols displayed in both the game reels and game wheels. As previously described herein, the wheel symbol display areas of the game wheel are arranged to visually and functionally align with the rows of reel symbol display areas in the game reels. Accordingly, the gaming system can evaluate symbols included in the wheel symbol display areas in combination with the reel symbol display areas along the above-describe pay lines. For example, if only one game wheel is active, the gaming system can evaluate combinations of the symbols displayed in the wheel symbol display areas of the one game wheel with symbols aligned with corresponding reel symbol display areas of the reels (e.g., along a horizontal pay line including the aligned symbols of the one wheel and the reels). And, if two game wheels are active, the gaming system can evaluate combinations of the symbols displayed in the wheel symbol display areas of both game wheels with symbols aligned with the corresponding reel symbol display areas of the reels (e.g., along the pay line including the aligned symbols of both wheel and the reels).

In such implementations, the gaming system may use different pay tables to determine winning combinations and awards than are used when evaluating winning reel symbol combinations alone.

At block 327, the gaming system can determine whether to activate the game wheels based on the reel symbols displayed at 321. In some implementations, the gaming device may rotate one or more of the game wheels based on the visible reel symbol display areas displaying a designated symbol or combination of symbols. For example, the gaming system may activate the a left game wheel (e.g., game wheel 412A in FIG. 4A) in the event that the leftmost game reel (e.g., game reel 402A) includes a wheel trigger symbol (e.g., symbol 411A, “Wheel!”), the gaming system may activate a right game wheel (e.g., game wheel 412B) in the event that a rightmost game reel (e.g., game reel 402E) includes a wheel trigger symbol (e.g., symbol 411B, “Wheel!”), and the gaming system may activate both wheels in the event that the leftmost game reel and the rightmost game reel include wheel trigger symbols. It is understood that other symbols, other symbol combinations, and other symbol display locations can be used to trigger activation of the game wheels.

If the gaming system determines not to activate the game wheels based on the displayed reel symbols (e.g., block 327 is “No”), then the method 300 proceeds to block 337 in FIG. 3C via off-page connector “B.” On the other hand, if the gaming system determines to activate the game wheels based on the displayed reel symbols, (e.g., block 327 is “Yes”), then at block 329 the gaming system randomly determines symbols for the game wheels in a same or similar manner to that previously described at block 315. In some implementations, determining the symbols at block 329 also includes determining new symbols for the reels, which can be performed in a same or similar manner to that previously described at block 319. The determination of wheel symbols and reel symbols in block 329 can use different sets of symbols than used to determine such symbols at blocks 315 and 319. Such sets can include, for example, different symbology and different symbol frequencies corresponding to different pay tables than used for the symbols determined at blocks 315 and 319.

At block 333, the gaming system determines winning symbol combinations of the reel symbols and the wheel symbols displayed in the wheel symbol display areas of the game wheels at 331. In some implementations, the gaming system only evaluates the reel and wheel symbols displayed across active or wagered pay lines for winning symbol combinations in a same or similar manner to that described above with regard to block 323. At block 335, the gaming system determines an award based on the winning symbol combinations determined at block 333, as well as any additional award symbols displayed in the active paylines, in a same or similar manner to that described above with regard to block 325. As noted above, blocks included in the method 300 can be rearranged or skipped. Accordingly, it is understood that some implementations of the method 300 may not include some or all of block 327-335.

Turning to FIG. 3C, as indicated by off-page connector “C,” at block 337, the gaming system updates the player's gaming credit balance in accordance with the award determined at blocks 325 and 335, if any. As noted above, the blocks illustrated in FIGS. 3A-3C can be rearranged in any suitable order. As such, it should be appreciated that the gaming system may update player's gaming credit balance at other times, such as at the completion of the game.

At block 339, the gaming system determines whether it received a request or signal to end game play or “cash out” via an input device of the gaming system (which would end the gaming session). In such a situation (e.g., block 339 is “Yes”), then at 343, the gaming system dispenses a value to the player, through a value dispenser, based on the player's gaming credit balance and the method 300 ends. On the other hand, if the gaming system has not received a request to end game play (e.g., block 339 is “No”), the method 300 returns to block 305 in FIG. 3A, as indicated by off-page connector C. The gaming system may receive, via a player input device, a wager for another play of the game and continue operation 300 from block 305. However, in some implementations, the wager may not be accepted if the player has fewer credits than the player's selected wager amount, as shown in block 315.

FIGS. 4A-4C show pictures of a game screen displayed by a gaming system in accordance with aspects of the present disclosure. More specifically, FIGS. 4A-4C illustrate screen shots a game screen 400 displayed on a display device (e.g., display device 120) in one implementation of the gaming system (e.g., gaming system 100). The game screen 400 includes game reels 401 and game wheels 412A, 412B. The game reels 401 comprise a set of virtual video game reels 402A-402E arranged substantially side by side so as to form a rectangular array. It should be appreciated that game reels 402A-402E can be displayed with different amounts of separation or no separation. The game reels 402A-402E include reel symbol display areas 410A-410T (a.k.a., symbol display positions). As illustrated in FIG. 4A, the symbol display areas 410A-410T are arranged so as to provide the appearance of a set of five game reels so as to represent a slot machine. In some implementations, such as illustrated in FIG. 4A, the five game reels may be arranged so as to visibly show four symbol display positions on each of the five game reels. For example, the symbol display areas 410A-410T are each associated with positions on reels 402A-402E, respectively. More specifically, in the example illustrated in FIG. 4A, reel symbol display areas 410A, 410F, 410K, and 410P are associated with reel 402A; reel symbol display areas 410B, 410G, 410L, and 410Q are associated with reel 402B; reel symbol display areas 410C, 410H, 410M, and 410R are associated with reel 402C; reel symbol display areas 410D, 410I, 410N, and 410S are associated with reel 402D; and reel symbol display areas 410E, 410J, 410O, and 410T are associated with reel 402E. When viewed together, reels 502A-502E appear like a 4-row by 5-column column reel array (i.e., matrix) in display 400. In other implementations, smaller (e.g., 3×3) or larger (e.g., 7×5) visible arrays of the reel symbol display areas can be displayed.

Each of the reels 402A-402E may display symbols in their respective reel symbol display areas 410A-410E that have been determined by the gaming system using sets of symbols. In some implementations, the reels 402A-402E are each respectively associated with a set of symbols, where each set of symbols includes a number of symbols. The sets of symbols can include the same or different symbols. As previously described herein, the symbols can include graphic symbology, pay symbols, modifier symbols, special symbols or designated symbols.

Prior to displaying the symbols, the gaming system may provide a display of the reels 402A-402E spinning to, for example, simulate the movement of mechanical game reels. As illustrated in FIG. 4B, the gaming system may show a display of spinning reels for each of the reels 402A-402E. The spinning may appear to occur in a vertical top to bottom direction or in a vertical bottom to top direction (not shown), or in a combination of vertical directions (not shown).

It is understood that other displays can be used that do not simulate reels of a slot machine. For example, the gaming system can display the game reels spinning in more than one direction, or the gaming system may not provide any display depicting the reels spinning. It is also understood that games other than a slot machine may be provided using the game reels 401. While reel symbol display areas are illustrated with defined boxes, it should be appreciated that in some implementations, the defined boxes are not visible to the player. It should also be appreciated that in some implementations, the symbol display areas are other shapes or not defined shapes and may not be associated with reels 402A-402E. Further, it should be also appreciated that the game shown in game screen 400 is merely representative and may have more or fewer game elements (e.g., reels, symbol display areas, symbols, etc.) shown in the game screen 400.

In accordance with aspects of the present disclosure, the game wheels 412A and 412B are configured to cooperate with the game reels 402A-402E during a game to provide one or more awards. As illustrated in FIG. 4A, the game wheel 412A can divided into a number of sections respectively including wheel symbol display areas 415A-415D, and the game wheel 412B can be divided into a number of sections respectively including wheel symbol display areas 415E-415H, the wheels 412A and 412B can be half-circles having their flat sides adjacent to or encompassing the distal end of the game reels 401. In some implementations, as illustrated in FIG. 4A, the wheel sections of games wheels 412A and 412B can arranged so that the respective wheel symbol display areas 415A-415H visibly align with reel symbol display areas 410 at the distal ends of the rows of the reels 402A-402E. In such arrangement, the wheel symbol display areas 415A, 415B, 415C, and 415D are substantially adjacent to or adjoined with reel symbol display areas 410A, 410F, 410K, and 410P, respectively. Additionally, the wheel symbol display areas 415E, 415F, 415G, and 415H are substantially adjacent to or adjoined with the reel symbol display areas 410E, 410J, 410O, and 410T, respectively. Accordingly, the wheel symbol display areas 415A and 415E functionally and visibly align with a row including reel symbol display areas 410A-410E; wheel symbol display areas 415B and 415F functionally and visibly align with a row including reel symbol display areas 410F-410J; wheel symbol display areas 415C and 415G functionally and visibly align with a row including reel symbol display areas 410K-410O; and wheel symbol display areas 415D and 415H functionally and visibly align with a row including reel symbol display areas 410P-410T.

The game wheels 412A, 412B may display symbols in their respective reel symbol display areas 415A-415H that have been determined by the gaming system using the sets of symbols. Prior to displaying the symbols, the gaming system may provide a display of the game wheels 412A, 412B rotating to, for example, simulate the movement of mechanical game wheels. As illustrated by the dashed lines in FIG. 4B, the gaming system can display the game wheels 412A, 412B rotating, which can occur in the same or different directions.

As illustrated in FIGS. 4A-4C, the reel display 401 is a 4×5 rectangular array and the game wheels 412A, 412B are four-segment half-circular arrays (e.g., half of eight segment full circles), wherein the four segments of the game wheels 412A, 412B align with the four rows of the reel display 401. It is understood that different combinations of reel displays 401 and game wheels 412A, 412 be can be used. For example, in some implementations, the reel display 401 can be a 3×5 rectangular array in which the three rows align with game wheels having three segments (e.g., half of six segment full circles).

Additionally, as illustrated in FIGS. 4A-4C, the game wheels 412A, 412B are shown as half-wheels, each including four wheel symbol display area 415A-415D and 415E-415H. It is understood that the game wheels 412A, 412B can be entire wheels or different portions of entire games wheels. Also, the game wheels 412A, 412B can include greater or fewer numbers of wheel symbol display areas 415. For example, in some implementations, the game wheels 412A, 412B can be half-circular arrays including four wheel symbol displays 415. And, in some implementations, the game wheels can be full-circular arrays including, for example, sixteen wheel symbol display areas 415.

As also illustrated in FIGS. 4A-4C, the reel display 401 may overlay the game wheels 412A, 412B. Accordingly, portions of the game wheels 412A, 412B (e.g., partial or full wheels) may be obstructed by the reel display 401 and the game reels 402A-402E, such that active wheel symbol display areas 415 of the game wheels 412A, 412B (e.g., wheel symbol display areas 415 at the leftmost and rightmost sides of the game reels 402A-402E that align with active pay lines of the reels 402A-402E) are visible, while inactive wheel symbol display areas 415 (e.g., wheel symbol display areas 415 that that do no align with active pay lines of the reels 402A-402E) are visibly obstructed. For example, the gaming device may determine wheel symbols for the game wheels 412A, 412B (such as previously described herein with regard to block 315) and display such wheel symbols (such as previously described herein with regard to block 317). The game symbols selected for wheel symbol display areas 415 that are inactive can be deemphasized (e.g., displayed with greater transparency or lower luminance) with respect to the active wheel symbol display areas 415 or not displayed. Further, as illustrated in FIGS. 4A-4C, the circumference of the game wheels 412A, 412B is greater than the height of the reel display. It is understood that the game wheels 412A, 412B, and the reel display 401 can have different proportions. For example, in some implementations, the circumference of the game wheels 412A, 412B can be the same or substantially the same as the height of the reel display 401 or the game reels 402A-402E.

Moreover, it is understood that the individual wheel symbol display areas 415 can have different selection probability weightings, such that the gaming system randomly selects one or more of the wheel symbol display areas 415 as an outcome (e.g., appearing in alignment with a row of reels 402A-402E) at unequal frequencies.

In addition to the game reels 402A-402E and the game wheels 412A, 412B, the game screen 400 can also include several information areas and buttons 405A-405I. These information areas and buttons 405A-405I are illustrated in a particular arrangement, but may be arranged in any suitable manner in different implementations. In some implementations, game screen 500 may include more or fewer display areas and buttons 405A-405I than illustrated.

Information area 405A illustrates an example value of one credit for the game displayed in game screen 400. Information areas 405B and 405C illustrate an example of the amount of the player's available credits. For example, the value displayed in information 405C (“2380”) may represent credit balance determined based on a monetary value received from a player via a value acceptor device (such as previously described with regard to blocks 301 and 303 of FIG. 3A). Information area 405D illustrates the amount of credits a player has won (such as previously described with regard to blocks 327 and 33 in FIG. 3B). For example, as illustrated in FIG. 4C, information area 405D shows “400” credits have been won. Notably, because FIG. 4A illustrates the start of a play of a game, the information area 405D shows zero credits have been won.

Button 405E illustrates a software button that the player can select to place wager (e.g., a bet, such as previously described with regard to block 305 in FIG. 3A). It should be appreciated that the functionality of button 405E may also be replicated or replaced with a hardware button on the gaming system 100. Information area 405F illustrates an amount of the wager made at information area 405E. For example, as illustrated in FIG. 4A, information area 405F indicates the player has selected to wager 10 credits.

Information area 405G illustrates a software button that the player can select to determine how many pay lines to wager on (such as previously described with regard to block 309 in FIG. 3A). It should be appreciated that the functionality of button 405G may also be replicated or replaced with a hardware button on the gaming system 100. Information area 505H illustrates a number of paylines selected by the player using information area 405G. For example, as illustrated in FIG. 4A, information area 405G indicates the player selected to wager on 10 pay lines. Button 405I illustrates a software button that the player can select to obtain information about the game, change certain aspects of the game, obtain help, place an order, etc.

To start a gaming session using the gaming system, a player provides the gaming system with a deposit of value, using one of the suitable mechanisms discussed above (such as previously described with regard to block 301 in FIG. 3A). The gaming system can validate the deposit of value received from the player. The gaming system can then issue credits (or gaming credits) to the player based on the received value (such as previously described with regard to block 303 in FIG. 3A). The credits enable the player to place wagers on the play of the game and initiate a play of a game. The gaming system may provide a visual indication of the player's credit balance to the player as discussed above in information area 405C.

To initiate the play of the game, the player activates or presses one or more appropriate buttons on the gaming system to deduct credits necessary to play the game and to identify the player's wager (such as previously described with regard to block 305 in FIG. 3A). The gaming system may deduct the appropriate credits from the player's credit balance after the wager or at any suitable time (such as previously described with regard to block 309 in FIG. 3A). In some implementations, the gaming system may also update the player's credit meter (information area 505C) to reflect the player's available credit balance. As an example, FIG. 4B shows the player's credit meter (information area 405C) decremented by 200 credits from 2380 to 2370 to reflect the 10 credit wager the player placed for the play of the game. Along with receiving the player's wager, the gaming system may receive pay line selections or other game functions the player wishes to activate in exchange for the wager (such as previously described with regard to block 309 in FIG. 3A). In some implementations, the gaming system automatically selects the pay lines for the player. The player may also actuate a game start button, a spin button, or a lever to initiate a play of a game (e.g., input device 115, such as previously described with regard to block 311 in FIG. 3A).

As previously detailed herein, the wheels 412A, 412B may be rotated in combination with the game reels 402A-402E. In various implementations, the rotation of the wheels 412A, 412B can be performed at the same, different, or overlapping times with the spinning of the game reels 502A-502E. As previously detailed herein, in some implementations, the gaming system may conditionally rotate the wheels 412A, 412B in response to predetermined events. In some such implementations, the gaming system may conditionally rotate the one or more of the wheels 412A, 412B based on an amount of a wager (such as previously described with regard to block 313 in FIG. 3A). Additionally or alternatively, in some implementations, the gaming device may conditionally rotate the wheels 412A, 412B based on the visible reel symbol display areas displaying a designated symbol or combination of symbols (such as previously described with regard to block 327 in FIG. 3B). For example, as illustrated in FIG. 4B, the gaming system may activate the wheel 412A in the event leftmost game reel 402A includes a wheel trigger symbol 411A (e.g., “Wheel!”), the gaming system may activate the wheel 412B in the event rightmost game reel 402E includes a wheel trigger symbol 411B, or the gaming system may activate both wheels 412A, 412B in the event leftmost game reel 402A and rightmost game reel 402E include wheel trigger symbols 411A and 411B.

For the play of the, the gaming system can randomly generate symbols from the associated sets of symbols for the wheels 412A, 412B (such as previously described with regard to block 315 in FIG. 3A) and for the reels 402A-402E (such as previously described with regard to block 319 in FIG. 3B). The gaming system can evaluate of the generated symbols on reels 402A-402E and the wheels 412A, 412B in FIG. 4C for winning symbol combinations (such as previously described with regard to block 323 in FIG. 3B). As noted above, the player may have wagered on one or more pay lines (such as 20 pay lines shown in information area 405H). In some implementations, at least the active (wagered on pay lines) are evaluated for winning symbol combinations. Any suitable number of pay lines may be used to evaluate winning symbol combinations.

It should be appreciated that the displayed symbol combinations shown in FIGS. 4A-4C are merely for explanatory purposes and the gaming system may randomly generate any suitable combination of symbols based on defined sets of symbols associated with the reels 402A-402E and the wheels 412A, 412B. As illustrated, for example, in FIG. 4C, the gaming system can display the generated symbols in the reel symbol display areas 410A-410T of the reels 402A-402E and in the wheel symbol display areas 415A-415H of the wheels 412A, 412B after the reels 402A-402E and the wheels 412A, 412B have stopped the spinning (such as previously described with regard to block 317 in FIG. 3A and block 321 in FIG. 3B).

In accordance with the example illustrated in FIGS. 4A-4C, the “Wheel!” symbols in reels 402A and 402E of FIG. 4A may be designated symbols that trigger the reels 402A-402E to spin and the wheels 412A, 412B to rotate (as previously described with regard to block 327 of FIG. 3B). An example of such spinning of the reels 402A-402E and rotation of the wheels 412A, 412B is shown in FIG. 4B, as indicated by the dashed lines In implementations, at least one of the reels 402A-402E and/or one of the wheel 412A, 412B may spin or rotate in a different direction than its counterparts. For example, wheel 412A may spin counterclockwise while wheel 412B spins clockwise.

FIG. 4C illustrates an example of the randomly-determined symbols that may be displayed by the reel symbol display areas 410A-410T and the wheel symbol display areas 415A-415H after the reels 402A-402E and the wheels 412A, 412B stop the spinning and rotating illustrated in FIG. 4B. In the present example, the gaming device may determine that, based on a pay table, the reel symbol display areas 410A-410C in a top row of the reel display 401 include a winning combination of the sequential symbols (i.e., A-Wild-A″) corresponding to an award. Additionally, the gaming device may increase such award based on the award symbol in the wheel symbol display area 415A (i.e., $10) aligned with winning combination in the top row. Notably, the symbol displayed in the wheel symbol display area 415E (i.e., Q) is also aligned with the top row. However, such symbol is not an award symbol and it does not match or combine with a sequence of symbols in the adjacent reel symbol display area 410E. As such, in the present example, the symbol in the wheel symbol display area 415E does not add to or modify the award.

Additionally, the example illustrated in FIG. 4C shows the bottom row of reel display 401 comprising reel symbol display areas 410P-410T includes a winning sequence of symbols (i.e., J-J-J-Wild-J) that, based on a pay table, may correspond to an award. Additionally, the gaming device may increase such award based on the symbol in the wheel symbol display areas 415D and 415H, which are both aligned with a pay line including winning combination in the bottom row. That is, gaming device may determine an award corresponding to the winning combination in the bottom row and modify such award based on the symbols in the wheel symbol display areas 415D and 415H. In the present example, the sequence of five symbols may pay a large award (e.g., $1,000), which may be increased by a multiple of five (i.e., 5X) based on the multiplier symbol in the wheel symbols display area 415D (i.e., “2X”) and the multiplier symbol in wheel symbol display area 415H. It is understood that the multiplier symbols may each multiply the award (i.e., 2X×3X=6X) rather than being added together to before multiplying the aware (i.e., 2X+3X=5X). It is also understood that some implementations (e.g., a bonus game) may include zero multiplier symbol (e.g., 0X), a “devil” symbol, or “whammy” symbol, or other such symbol the zeros any award include in a pay line in which such symbol is included.

The gaming system may update the information area 405D to reflect the award or amount of credits the player has won and may also update the player's gaming credit balance (505C) in accordance with the calculated award amount for the play of the game (such as previously described with regard to block 335 in FIG. 3B). In some implementations, the play of the game ends. The player may continue the gaming session (e.g., play another consecutive play of the game) by executing another play of the game (such as previously described with regard to block 339 in FIG. 3B). That is, the player may place another wager and start a new play of the game as noted above. However, continued game play is dependent of the number of credits remaining in the player's credit balance. The player may also choose to cash out. In such an instance, the gaming system provides the player a value based on the player's credit balance using any of the value items discussed above (bills, coins, vouchers, etc.).

As detailed above, the present application discloses specialized computing devices that provide technical improvements in the art of gaming systems. Implementations disclosed herein technically improve the operation of gaming systems for their specialized purpose by generating and displaying two different types of game displays (e.g., a reel-type game and a wheel-type game) on a game screen substantially concurrently and operating such game displays in cooperation. Such implementations reduce power consumption used by the gaming system by providing the two types of games display on a game screen of one display device, instead of using more than one display device. Implementations also reduce the physical complexity and manufacturing cost of the gaming system. Further, implementations concurrently providing two types of game displays s also can complete games more quickly, which can increase the usage rate of the gaming system. Moreover, in some implementations, generating and displaying two different types of game displays on a game screen substantially concurrently reduces processing load and memory consumption of the gaming system by avoiding generation, display, and evaluation of portions the first game display (e.g., a wheel-type game display) that are occluded by the display of the second game display (e.g., a reel type game display).

Based on the forgoing description, it should be appreciated that a gaming system and method with improvements to game outcomes by unlocking additional symbols creates new and very exciting ways for a player to obtain improved winnings with a potential to earn greater awards. Such a potential to earn greater awards creates a greatly improved sense of anticipation for players.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations of the invention have been described. Various modifications may be made without departing from the spirit and scope of the invention. For example, various forms of the flows shown above may be used, with steps re-ordered, added, or removed. Accordingly, other implementations are within the scope of the following claims.

1. A gaming system comprising:
a value acceptor;
a value dispenser;
a player input device;
one or more display devices;
a random number generator;
a memory device; and
a processor;
wherein the memory device stores program instructions that, when executed by the processor, cause the gaming system to:
display at least one game wheel comprising a plurality wheel symbol display areas;
display a plurality of reel symbol display areas arranged in a rectangular array, wherein at least one row of the rectangular array is aligned with at least one wheel symbol display area of the at least one game wheel;
receive, by the value acceptor, a monetary value;
establish a credit balance based on the monetary value;
receive, via the player input device, a wager;
initiate a play of a game based on the wager;
randomly determine a plurality of reel symbols for the plurality of reel symbol display areas;
randomly determine one or more wheel symbols for the plurality of wheel symbol display areas;
display, using the one or more display devices, the plurality of reel symbols in the plurality of reel symbol display areas;
display, using the one or more display devices, the one or more wheel symbols in the at least one wheel symbol display areas;
determine one or more winning symbol combinations based on the plurality of reel symbols;
determine an award based on the one or more winning symbol combinations and the one or more wheel symbols displayed in the at least one wheel symbol display area;
display, using the one or more display devices, the award;
update the credit balance with the value of the award; and
issue, using the value dispenser, a value based on the updated amount of the credit upon receipt of a cash out request.

2. The gaming system of claim 1, wherein
the at least one game wheel includes a first game wheel and a second game wheel;
a first wheel symbol display area of the first game wheel is adjacent to a leftmost reel in the at least one row of the rectangular array; and
a second wheel symbol display area of the second game wheel is adjacent to a rightmost reel in the at least one row of the rectangular array.

3. The gaming system of claim 2, wherein:
the rectangular array includes at least three rows; and
the at least three rows of the rectangular array respectively adjoin at least three wheel symbol display areas of the first game wheel and at least three wheel symbol display areas of the second game wheel.

4. The gaming system of claim 3, wherein the rectangular array comprises at least three columns comprising at least three reels configured to rotate in a vertical direction.

5. The gaming system of claim 4, wherein the first game wheel and the second game wheel are configured to rotate in a direction orthogonal to the vertical direction of the at least three reels.

6. The gaming system of claim 1, wherein at least three rows of the rectangular array are aligned with at least three wheel symbol display areas of the at least one game wheel.

7. The gaming system of claim 1, wherein the one or more wheel symbols comprise pay symbols corresponding to a second award that is separate from the award.

8. The gaming system of claim 1, wherein the one or more wheel symbols comprise modifier symbols that modify the award.

9. The gaming system of claim 1, wherein:
randomly determining the plurality of reel symbols comprises randomly selecting the plurality of reel symbols from one or more sets of reel symbols;
randomly determining the one or more wheel symbols comprises randomly selecting the plurality of wheel symbols from one or more sets of wheel symbols;
the gaming system stores, using a storage system, one or more pay tables associating one or more awards with one or more first winning symbol combinations of reel symbols of the set of reel symbols and the wheel symbols in the set of reel symbols;
determining the one or more winning symbol combinations comprises determining the winning symbol combination based on the plurality of reel symbols displayed in the at least one row and based on the one or more wheel symbols; and
determining the award comprises determining, using the pay table, the award corresponding to the winning symbol combination of the plurality of reel symbols displayed in the at least one row and based on the one or more wheel symbols.

10. A method of operating a gaming system comprising:
receiving, by a processor via a value acceptor, a monetary value;
establishing, by the processor, a credit balance based on the monetary value;
receive, by the processor via a player input device, a wager;
initiate, by the processor, a play of a game based on the wager;
displaying, by the processor using a display device, at least one game wheel comprising a plurality wheel symbol display areas;
displaying, by the processor using the display device, a plurality of reel symbol display areas arranged in a rectangular array, wherein at least one row of the rectangular array is aligned with at least one wheel symbol display area of the at least one game wheel;
randomly determining, by the processor, a plurality of reel symbols for the plurality of reel symbol display areas;
randomly determining, by the processor, one or more wheel symbols for the plurality of wheel symbol display areas;
displaying, by the processor using the display device, the plurality of reel symbols in the plurality of reel symbol display areas;
displaying, by the processor using the display device, the one or more wheel symbols in the at least one wheel symbol display areas;
determining, by the processor, one or more winning symbol combinations based on the plurality of reel symbols;
determining, by the processor, an award based on the one or more winning symbol combinations and the one or more wheel symbols displayed in the at least one wheel symbol display area;
displaying, by the processor using the display device, the award;
updating, by the processor, the credit balance with the value of the award; and
issuing, by the processor using a value dispenser, a value based on the updated amount of the credit upon receipt of a cash out request via a second player input device.

11. The method of claim 10, wherein
the at least one game wheel includes a first game wheel and a second game wheel;
a first wheel symbol display area of the first game wheel is adjacent to a leftmost reel in the at least one row of the rectangular array; and
a second wheel symbol display area of the second game wheel is adjacent to a rightmost reel in the at least one row of the rectangular array.

12. The method of claim 11, wherein:
the rectangular array includes at least three rows; and
the at least three rows of the rectangular array respectively adjoin at least three wheel symbol display areas of the first game wheel and at least three wheel symbol display areas of the second game wheel.

13. The method of claim 12, wherein the rectangular array comprises at least three columns comprising at least three reels.

14. The method of claim 13, further comprising rotating the first game wheel and the second game wheel in a direction orthogonal to a spin direction of the at least three reels.

15. The method of claim 10, wherein at least three rows of the rectangular array are aligned with at least three wheel symbol display areas of the at least one game wheel.

16. The method of claim 10, wherein the one or more wheel symbols comprise pay symbols corresponding to a second award that is separate from the award.

17. The method of claim 10, wherein the one or more wheel symbols comprise modifier symbols that modify the award.

18. The method of claim 10, wherein:
randomly determining the plurality of reel symbols comprises randomly selecting the plurality of reel symbols from one or more sets of symbols;
randomly determining the one or more wheel symbols comprises randomly selecting the plurality of wheel symbols from the one or more sets of symbols;
the gaming system stores, using a storage system, one or more pay tables associating one or more awards with one or more first winning symbol combinations of reel symbols of the set of reel symbols and the wheel symbols in the set of reel symbols;
determining the one or more winning symbol combinations comprises determining the winning symbol combination based on the plurality of reel symbols displayed in the at least one row and based on the one or more wheel symbols; and
determining the award comprises determining, using the pay table, the award corresponding to the winning symbol combination of the plurality of reel symbols displayed in the at least one row and based on the one or more wheel symbols.

19. A computer program product comprising non-transitory computer-readable device storing program instructions that, when executed by a processor of a gaming system, cause the gaming system to perform operations, the operations comprising:
providing, using one or more display devices, a wheel and reel game, wherein:
the wheel and reel game includes at least one game wheel comprising a plurality wheel symbol display areas arranged,
the wheel and reel game includes a plurality of reel symbol display areas arranged in a rectangular array,
at least one row of the rectangular array is aligned with at least one wheel symbol display area of the circular array;
receiving, by the processor from a value acceptor, a monetary value;
establishing, by the processor, a credit balance based on the monetary value;
receiving, by the processor from a player input device, a wager;
initiating, by the processor, a game based on the wager;
randomly determining, by the processor, a plurality of reel symbols for the plurality of reel symbol display areas;
randomly determining, by the processor, one or more wheel symbols for the plurality of wheel symbol display areas;
displaying, by the processor using the one or more display devices, the plurality of reel symbols in the plurality of reel symbol display areas;
displaying, by the processor using the one or more display devices, the one or more wheel symbols in the at least one wheel symbol display area;
determining, by the processor, one or more winning combinations based on the plurality of reel symbols;
determining, by the processor, an award based on the one or more winning combinations;
displaying, by the processor using the one or more display devices, the award;
updating, by the processor, the credit balance with the value of the award; and
issuing, by the processor using a value dispenser, a value based on the updated amount of the credit upon receipt of a cash out request via a second player input device.

20. The computer program product of claim 19, wherein:
randomly determining the plurality of reel symbols comprises randomly selecting the plurality of reel symbols from one or more sets of symbols;
randomly determining the one or more wheel symbols comprises randomly selecting the plurality of wheel symbols from the one or more sets of symbols;
the gaming system stores, using a storage system, one or more pay tables associating one or more awards with one or more first winning symbol combinations of reel symbols of the set of reel symbols and the wheel symbols in the set of reel symbols;
determining the one or more winning symbol combinations comprises determining the winning symbol combination based on the plurality of reel symbols displayed in the at least one row and based on the one or more wheel symbols; and
determining the award comprises determining, using the pay table, the award corresponding to the winning symbol combination of the plurality of reel symbols displayed in the at least one row and based on the one or more wheel symbols.
